(19) United States
(12) Patent Application Publication
(10) Pub. No.: US 2013/0045392 A1
(43) Pub. Date: Feb. 21, 2013

(54) METHOD FOR PREPARING HYDROPHOBIZED BIOMATERIALS, HYDROPHOBIZED BIOMATERIALS AS OBTAINED AND USES THEREOF

(71) Applicants: Valérie Langlois, Cachan (FR); Estelle Renard, Bourg-La-Reine (FR); Xavier Samain, Lille (FR)

(72) Inventors: Valérie Langlois, Cachan (FR); Estelle Renard, Bourg-La-Reine (FR); Xavier Samain, Lille (FR)

(73) Assignee: Centre National de la Recherche Scientifique (C.N.R.S), Paris (FR)

(21) Appl. No.: 13/580,365

(22) PCT Filed: Feb. 24, 2011
(86) PCT No.: PCT/FR2011/050386

§ 371 Date: Nov. 6, 2012

(30) Foreign Application Priority Data
Feb. 24, 2010 (FR) 1051308

(51) Int. Cl. C08G 63/91; B32B 27/36; C08L 67/04; C08L 1/02; C08L 3/02

(52) U.S. Cl. 428/480; 525/54.21; 525/450; 525/54.2

(57) ABSTRACT

The present invention relates to a method for preparing a hydrophobized biomaterial consisting of a hydrophilic material, notably selected from vegetable fibers having hydroxyl functions, on which are grafted chains of polymers having ester functions, said method comprising a step for putting said hydrophilic material in contact with said polymers and for a transesterification reaction between said ester functions and said hydroxyl functions.

The object of the present invention is a method for preparing hydrophobized biomaterials, notably based on cellulose, as well as the biomaterials as obtained and uses thereof.

The majority of the scientific community recognizes the role of human activity on climate warming. If the occurrence of this phenomenon appears today to be inevitable, it is not too late to limit the extent thereof. The world therefore has to meet the challenge of reducing greenhouse gas emissions. Further, beyond any ecological consideration, the short supply of fossil resources is a threat for the entire community. The volatility on the price of raw materials may actually endanger many economical sectors. Plastic engineering is notably in first line because of its strong dependence on petroleum. More than any other material, the price of the oil barrel is directly passed on onto that of plastic materials and it is indispensable today to prepare solutions to the shortage of cheap oil which will not fail to occur tomorrow.

The use of polymer in motor vehicles has doubled during the last 25 years for reasons of facility, design, lightness and cost. These plastics or resins are frequently applied in the form of composites for improving their mechanical properties. A composite frequently consists of a continuous matrix in which a rigid strengthening phase, very often in the form of fibers, is dispersed. The properties of composites first of all depend on their constituents, on their chemical natures and on their structures. The interface between the fibers and the matrix also plays a very significant role on its mechanical properties. The interface should allow transfer of stress from the matrix to the fibers through shear stress in order to lead to efficient strengthening (V. Dutschk et al., Mechanics of Composite Materials. 1998, 34, 431). When the reinforcement is formed with glass fibers, the difficulty in separating the fibers from the matrix poses serious problems for recycling and upgrading composites (R. Zah et al., Journal of Cleaner Production. 2006, 15, 1032).

These constraints have caused increased interest for composite materials of renewable origin. The problem of the interface is also posed with biocomposites. The hydrophilicity of fibers of natural origin is often a cause of incompatibility with the hydrophobicity of the polymers. A certain number of studies have already been conducted on this subject, but a greater research effort is still necessary for improving the surface characteristics of biocomposites (P. A. Fowler et al., J Sci Food Agric. 2006, 86, 1781).

Cellulose is the most abundant plant structuration material in nature. It is well known that this polymer may be chemically modified, incorporated into composites, used as mixtures, or become part of copolymers. Recent concern about the environment has led research into the field of natural fibers for modifying cellulose in order to increase its versatility and extend the spectrum of its application. Two sorts of modifications by grafting exist: grafting, called “grafting-from” which consists of preparing grafts by polymerization of a monomer by reaction with a reactive lateral function, or by grafting, “grafting-onto”, and in this case it is an oligomer which is attached to the macromolecular backbone.

With constant progress in the field of macromolecular synthesis, it was possible to multiply the materials obtained by grafting and to extend the properties and therefore the applications of cellulose.

However, up to now, the methods used required too restrictive experimental conditions and not attractive for the moment. Indeed, for example, polymerization by opening lactone rings requires operating under anhydrous conditions.

One of the goals of the present invention therefore consists of providing composite materials prepared from renewable materials.

Another object of the present invention therefore consists of providing a simple and not very costly method, which may easily be transposed industrially for preparing composite materials of renewable origin.

The object of the present invention is to provide a method for treating renewable materials so as to improve their compatibility with thermoplastic polymeric matrices, by modifying certain chemical functions of said renewable materials without however altering their structure.

The object of the present invention is also to provide composite materials of renewable origin having high performances and which may be applied by usual industrial techniques, i.e. by an injection or extrusion process.

Thus, the present invention relates to a method for preparing a hydrophobized biomaterial consisting of a hydrophilic material having hydroxyl functions, onto which are grafted chains of polymers having ester functions, said method comprising a step for putting said hydrophilic material in contact with said polymers and for a transesterification reaction between said ester functions and said hydroxyl functions.

The hydrophilic material is advantageously selected from vegetable fibers, silica, dextrans or cyclodextrin oligomers and derivatives thereof.

Thus, the present invention relates to a method for preparing a hydrophobized biomaterial consisting of a hydrophilic material, notably selected from vegetable fibers, having hydroxyl functions, onto which are grafted chains of polymers having ester functions, said method comprising a step for putting said hydrophilic material in contact with said polymers and for a transesterification reaction between said ester functions and said hydroxyl functions. The biomaterial obtained according to the method of the invention may also be designated as “composite biomaterial” or “biocomposite”.

The term of “composite material” designates a material in the solid phase consisting of at least two constituents, the respective properties of which complement each other in order to form a material with improved global performances. A structural composite material generally consists of a reinforcement and of a matrix. The reinforcement, the most often in a fibrous or filamentary form, provides the essential of the mechanical properties. The matrix plays the role of a binder in order to protect the reinforcement from the environment and to maintain it in its initial position and to ensure transmission of forces.

A composite is defined as the mixture of two or several phases which leads to superior properties as compared with those of the constituents taken individually. A composite frequently consists of a continuous matrix in which a rigid strengthening phase, very often in the form of fibers, is dispersed. The role of the matrix is to transfer the outer stresses towards the fibers and to protect the reinforcement. The properties of the composites first of all depend on their constituents, on their chemical natures and on their structures. But the interface between the fibers and the matrix also plays a very significant role on the mechanical properties.

The term of “biocomposite” or “composite biomaterial” designates a material which contains at least one phase from the biomass, or else a material which comprises constituents all originating from the biomass.

The hydrophobized biomaterials of the invention are prepared from a hydrophilic material and the method of the invention consists of hydrophobizing said material, notably selected from vegetable fibers, having hydroxyl functions (i.e. chemically modifying said hydroxyl functions for making said material hydrophobic).

The biomaterials obtained according to the method of the invention are materials made hydrophobic by transesterification. They are therefore designated as “hydrophobized biomaterials”. They consist in hydrophilic materials, notably selected from vegetable fibers, made hydrophobic by transesterification between ester functions of polymers and hydroxyl functions of said materials.

A compound is said to be hydrophilic when it absorbs water. A hydrophilic compound is typically polar. This gives it the possibility of generating hydrogen bonds with water or a polar solvent. Within the scope of the present invention, the applied hydrophilic materials comprise at least one hydroxyl functional group (or alcohol function).

The hydrophilicity of the fibers of natural origin is often a cause of incompatibility with the hydrophobicity of the polymers. Thus, the method of the invention consists of making these fibers hydrophobic.

The polymers having ester functions used within the scope of the present invention may for example be polymers comprising ester functions as well as other functional groups or polyesters.

Generally, the term of “ester function” designates a group of atoms of the —COO-alkyl type.

The method of the present invention consists in a transesterification between the ester functions of the polymers and the hydroxyl functions of the hydrophilic material, and notably of the vegetable fibers.

The biomaterial of the invention therefore consists of a hydrophilic material, notably selected from vegetable fibers, in which the hydroxyl functions have been transesterified and therefore onto which chains of polymers are covalently grafted (or bound) via ester functions.

The method of the invention comprises a simple step for putting both constituents of the biomaterial in contact, i.e. a step for putting into contact the hydrophilic material, notably selected from vegetables fibers and polymers having ester functions, followed by a transesterification reaction step between the alcohol functions of said material and the ester functions of the polymers.

The method of the present invention consists of hydrophobizing an initially hydrophilic material. This will equally be referred to as a hydrophobized material or a grafted material or further a modified material.

The method of the present invention advantageously comprises the following steps:

a) a step for putting the hydrophilic material, notably selected from vegetable fibers, having hydroxyl functions, into contact with polymers having ester functions; and

b) a transesterification step between the ester functions of the polymers and the hydroxyl functions of said material.

Thus at the end of this process, a hydrophobized material is recovered.

According to a particularly advantageous embodiment of the method of invention, the transesterification step is carried out at a temperature comprised from 70° C. to 250° C., preferably from 100° C. to 200° C., and preferentially from 140° C. to 190° C.

According to a particularly preferred embodiment of the method according to the present invention, the vegetable fibers having hydroxyl functions are selected from: cellulose and its derivatives, flax fibers (notably Durafiber, Grade One, 95% purity), hemp fibers, abaca fibers, jute fibers, kenaf fibers, lyocell fibers (tencel), pine fibers, rayon fibers (notably Cordenka®), sisal fibers, beetroot pulp, viscose fibers (notably Enkaviscose®) and nettle fibers.

Among cellulose derivatives, mention may notably be made of recycled cellulose fibers CreaMix TC 1004 and defibrillated cellulose fibers.

Cellulose is the most abundant plant structuration material in nature and its use is multiple in fields as diverse at textiles, paper, drugs, personal hygiene products and all associated with sustainable development. The associated cellulose macromolecules form microfibrils which themselves are associated in layers, forming the walls of the vegetable fibers. Hydrogen bonds are established between the glucose molecules of the various chains.

More preferably, the present invention relates to a method for preparing hydrophobized cellulose (or further designated as grafted cellulose or modified cellulose) comprising a step for putting the cellulose into contact with at least one polymer having ester functions and a transesterification step between the ester functions of said polymer (or of the polymers) and hydroxyl functions of the cellulose.

Preferentially, the present invention relates to a method for preparing a hydrophobized hydrophilic material, notably selected from silica, dextran or a cyclodextrin polymer, comprising a step for putting said material into contact with at least one polymer having ester functions and a transesterification step between the ester functions of said polymer (or polymers) and the hydroxyl functions of said material. The method of the present invention may also comprise the putting of a hydrophilic material as defined above in contact with one or several polymers having ester functions. Thus, when the method comprises the use of several polymers, the latter may be identical or of different nature.

Among the polymers having ester functions, mention may notably be made of aliphatic polyesters.

The term of “aliphatic polyester” designates a polyester in which the ester functions are bound together with aliphatic groups.

Thus, according to a particular embodiment, the aliphatic polyesters have the following structure:

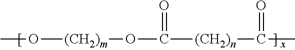

wherein:

m is an integer comprised from 2 to 10, n is an integer comprised from 0 to 18, x is an integer greater than 1.

Specific examples of these aliphatic polyesters comprise:

succinate-based aliphatic polymers, such as polybutylene succinate, polyethylene succinate, polypropylene succinate and copolymers thereof (notably polybutylene succinate adipate);

oxalate-based aliphatic polymers, such as polyethylene oxalate, polybutylene oxalate, polypropylene oxalate and their copolymers;

malonate-based aliphatic polymers, such as polyethylene malonate, polypropylene malonate, polybutylene malonate and copolymers thereof;

adipate-based aliphatic polymers, such as polyethylene adipate, polypropylene adipate, polybutylene adipate, polyhexylene adipate and copolymers thereof; as well as the mixtures of all these polymers or copolymers.

Among the polymers which may be used within the scope of the present invention, mention may notably be made of polybutylene succinate (PBS) with the following structure:

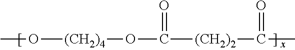

Among the aliphatic polyesters, mention may also be made of the polymers described in patents U.S. Pat. No. 5,714,569, U.S. Pat. No. 5,883,199, U.S. Pat. No. 6,521,366 and U.S. Pat. No. 6,890,989.

Preferably the polymers having ester functions according to present invention are selected from biodegradable polymers such as poly(glycolic acid) (PGA), poly(lactic acid) (PLA), poly(β-malic acid) (PMLA), poly(c-caprolactone) (PCL), poly(p-dioxanone) (PDS), polybutylene succinate (PBS) and poly(3-hydroxybutyrate) (PHB).

According to a particularly advantageous embodiment, the polymers having ester functions according to the present invention are selected from polyesters of the family of poly(3-hydroxyalkanoates) (PHA), notably poly(3-hydroxybutyrate) (PHB), poly(3-hydroxybutyrate-co-3-hydroxyvalerate) (PHBHV), poly(3-hydroxybutyrate-co-hydroxyhexanoate) (PHBHHx), poly(3-hydroxy-octanoate)(PHO) and poly(lactic acid)(PLA).

Among polyesters from renewable resources, PLA may be obtained from the following suppliers: NatureWorks (Cargill—USA), Eco Plastic (Toyota—Japan), Lacty (Shimadzu—Japan), Treofan (Treofan—The Netherlands), Lacea (Mitsui Chemicals—Japan), CPLA (Dainippon Ink Chem.—Japan), PLA (Purac—The Netherlands), Ecoloju (Mitsubishi—Japan) and Biomer L (Biomer—Germany).

PHA may be obtained from the following suppliers: Biocycle (PHB Industrial—Brazil), Metabolix (Metabolix/ADM—USA), Enmat (Tianan—China), Biomer P (Biomer—Germany) and Nodax (Procter & Gamble).

Among polyesters from fossil resources, PCL may be obtained from the following suppliers: CAPA (Solvay—Belgium) and TONE (Union Carbide—USA).

The copolyesters may be obtained from the following suppliers: Bionolle (Showa—Japan), Ecoflex (BASF—Germany), Biomax (Dupont—USA), EnPol (Ire Chemical—South Korea), Lunare SE (Nippon Shokubai—Japan), Celgreen (Daicel—Japan) and Origo-Bi (Novamont-Italy).

According to a preferential embodiment, the transesterification step is carried out under microwave irradiations.

According to a particular embodiment, the step of the method of the invention for contact between the hydrophilic material and the polymers having ester functions is a step consisting of heating said hydrophilic material and the polymers having ester functions in the absence of any solvent and preferably in the absence of any catalyst.

This embodiment of the method consists in an impregnation in the molten state and notably consists of heating and pressing a layer of said hydrophilic material between two layers of polymers having ester functions.

More preferably, the step for putting the hydrophilic material in contact with the polymers having ester functions is a step consisting of immersing said hydrophilic material in a solution comprising a suitable solvent in which the polymers having ester functions have been solubilized.

This preferential embodiment therefore consists of immersing (soaking) the hydrophilic material which one wishes to make hydrophobic, into a solution consisting of a solvent and of polymers(s), notably aliphatic polyesters.

This immersion step is followed by a heating step which causes transesterification between the ester functions of said polymer (or polymers) and the hydroxyl functions of the hydrophilic material.

This immersion step is generally followed by a step for drying the modified (hydrophobized) material before transesterification, preferably at room temperature, in order to remove the residual solvent.

Preferably, the duration of said immersion step is comprised from 10 minutes to 120 minutes and is preferably equal to 15 minutes.

The method of the present invention may comprise several immersion cycles and several heating cycles. The hydrophilic material may therefore be soaked in a solution comprising the solvent and the polymer(s) several times.

Preferably, a single immersion cycle is carried out, i.e. the hydrophilic material is soaked once in the aforementioned solution.

Within the scope of this immersion step, the concentration of polymers having ester functions in the aforementioned solution (i.e. comprising the polymers solubilized in a solvent) is comprised from 10 g.L⁻¹ to 100 g.L⁻¹, preferably from 10 g.L⁻¹ and 50 g.L⁻¹, and preferentially equal to 50 g.L⁻¹.

Preferably when the polymer is PHB, this concentration is equal to 50 g.L⁻¹.

Among the solvents which may be used for this immersion step, i.e. solvents in which the polymers having ester functions as defined above are soluble, mention may preferably be made of solvents selected from the group consisting of dichloromethane, chloroform, tetrahydrofurane and mixtures thereof.

Preferentially, when the polymer is PHB or PHBHV, dichloromethane or chloroform are used as a solvent.

Preferentially, when the polymer is PHO or PLA, dichloromethane, chloroform or tetrahydrofurane are used as a solvent.

Advantageously, the method of the present invention is carried out in the absence of any catalyst.

As a reminder here, a catalyst is a substance which increases or reduces the rate of a chemical reaction; it participates in the reaction but is regenerated at the end of the reaction. Therefore, it is not part of the reagents or of the obtained products.

A preferred embodiment or the present invention consists in a method for hydrophobizing cellulose, comprising the following steps:

a step for immersion of cellulose in a solution comprising a suitable solvent in which one or several polymers having ester functions have been solubilized and more particularly in a solution comprising a solvent and one or several polymers selected from PHA, PLA, PHB, PHBHV, PCL and PHO, and

a step for transesterification between the ester functions of said polymer (or polymers) and the hydroxyl functions of cellulose, at a temperature comprised from 70° C. to 250° C., preferably from 170° C. to 190° C.

At the end of this process, hydrophobized cellulose is thus recovered.

The method of the present invention therefore notably consists of hydrophobizing cellulose mats by reaction between an aliphatic polyester and the hydroxyl groups of the cellulose (esterification of the hydroxyl functions of the cellulose and transesterification of the polyester). The reaction does not require any prior treatment of cellulose.

This reaction is conducted with the native polymer of high molar mass without it being necessary to functionalize it beforehand. This reaction is notably conducted in the solid state under hot conditions simply by putting both partners into contact without adding any catalyst. Optimization of the experimental conditions allows cellulose to be hydrophobized regardless of the nature of the polyester used. Hydrophobization of cellulose gives the possibility of contemplating the preparation of biocomposites entirely biosourced by an extremely simple process and easily transposable to a large scale.

The present invention also relates to a hydrophobized biomaterial which may be obtained according to the method as defined above, characterized in that it consists of a hydrophilic material, notably selected from vegetable fibers, having hydroxyl functions onto which are grafted chains of polymers having ester functions.

The present invention also relates to a hydrophobized biomaterial which may be obtained according to the methods defined above, characterized in that it consists of vegetable fibers having hydroxyl functions onto which are grafted chains of polymers having ester functions.

In particular, the hydrophobized biomaterial according to the present invention, and more particularly hydrophobized cellulose, has a contact angle with water of at least 115°, preferentially of at least 120°, and notably at least 130°.

The measurement of the contact angle is a technique which accounts for the capability of a liquid of spreading over a surface by wettability. The method consists of measuring the angle of the tangent of the profile of a drop deposited on the substrate, with the surface of the substrate. It allows measurement of the surface energy of the liquid or of the solid.

By measuring the contact angle, it is possible to discriminate between the polar nature or apolar nature of the interactions and the liquid-solid interface. It is thus possible to infer hydrophilicity or hydrophobicity of a surface.

The measurement of this contact angle in the presence of water gives the possibility of inferring the hydrophobicity of the surface (hydrophobized biomaterial of the invention), considering the high value of this angle.

The present invention also relates the use of a hydrophobized biomaterial as defined above for preparing composite materials.

The present invention therefore also relates to a composite material comprising a hydrophobized biomaterial as defined above and a polymer.

In these composite materials comprising at least one layer consisting of the hydrophobized biomaterial of the invention, and preferably comprising at least one layer consisting of hydrophobized cellulose, the polymer may be identical with or different from the polymer(s) comprising the ester functions grafted on said hydrophobized biomaterial.

For example, treating the cellulose fibers gives the possibility of improving their compatibility with a thermoplastic polymeric matrix.

The present invention also relates to a composite material of the “sandwich” type comprising a layer consisting of hydrophobized biomaterial as defined above and of two polymer layers, said polymer layers being respectively above and below the hydrophobized biomaterial layer.

The polymer of these composite materials is selected from thermoplastic polymeric matrices and may be of the same nature or of a nature different from the polymers used for grafting the ester functions on the material to be hydrophobized.

According to a preferred embodiment, the present invention relates to a composite material of the “sandwich” type comprising a layer consisting of hydrophobized cellulose as defined above and of two layers of polymers, notably PLA or PHAs.

### FIGURES

FIG. 1 represents the amount of polyester adsorbed on cellulose versus the immersion time at a concentration of 50 g/L. The axis of the abscissae represents the immersion time (in minutes) and the axis of the ordinates represents the amount of grafted polymer Δm/m (%). The curve with the squares corresponds to PHBHV, the curve with the lozenges corresponds to PHO and the curve with the white squares corresponds to PLA.

FIG. 2 represents the influence of the number of immersion cycles of the cellulose on the amount of adsorbed polyester. The axis of the abscissae indicates the number of immersion cycles (1,2 or 3) and the axis of the ordinates the mass of the grafted polymer (in mg). The black bars correspond to PHO and the white bars correspond to PHBHV.

FIG. 3 represents the influence of the concentration of the polyester on the amount of adsorbed polymer. The axis of the abscissae represents the concentration of the polyesters (in g/L) and the axis of the ordinates the amount of grafted polymer Δm/m₀ (%). The curve with the squares corresponds to PHBHV; the curve with lozenges corresponds to PHO; the curve with triangles corresponds to PHB and the curve with white squares to PLA.

FIGS. 4 and 5 represent the absorbance ratios of cellulose after transesterification with PHO, PLA and PHB at 170° C. (FIG. 4) and at 190° C. (FIG. 5). The axis of the abscissae represents the duration (in minutes) and the axis of the ordinates the ratio between absorption due to the elongational vibration of the ester function at 1745 cm⁻¹ and the absorbance of the OH bond of water bound to cellulose at 1645 cm⁻¹. The curve with the squares corresponds to PHO; the curve with the crosses corresponds to PLA and the curve with the triangles corresponds to PHB.

### EXAMPLES

Products Used

As a vegetable fiber, cellulose was used as provided by Alstrom. The paper used is a mixture of wood fibers containing 71% of softwood and 29% of hardwood. It is made on a continuous paper-making machine. Its base weight is 90 g/m² and its thickness is 0.32 mm.

The polymers used are: poly(lactic acid) PLA (Cargill), PHB (Biomer), polycaprolactone (Aldrich) and poly(3-hydroxybutyrate-co-3-hydroxyvalerate) (ICI), PHBHV (produced by Biomer), PHBHV (produced by Goodfellow), poly(3-hydroxy-octanoate), the characteristics of which are given in Table 1 hereafter:

The silica used is AEROSIL 150 silica, the dextran used is T10 Pharmacia Biotech dextran and finally the cyclodextrin polymer was prepared according to the operating procedure described in E. Renard, A. Deratani, G. Volet, B. Sebille, Eur. Polym. J., 33,1,49-57(1997).

TABLE 1
Characterization of polyesters:

| Polymers | T_{g} (° C.) | Tₘ (° C.) |
|---|---|---|
| PHB | 8 | 176 |
| PHBHV | 8 | 158 |
| PHO | −40 | 55 |
| PLA | 60 | |
| PCL | −60 | 60 |

A. Biocomposites Prepared from Cellulose

Operating Procedure—Preparation of Biocomposites

The polymers were put into solution beforehand in dichloromethane.

The cellulose was immersed in the solution at room temperature. The influence of the polyester concentration (1 to 50 g/L), the impregnation duration (15 to 120 minutes) and the number of impregnations (1 to 3) was studied systemically. The step for impregnation of the cellulose was carried out with stirring by means of a magnetized bar. The cellulose sheet was then removed from solution and placed in an oven.

The amount of grafted polymer is calculated in the following way:

Δm=mₜ−m₀ wherein m₀ is the initial mass of the cellulose and mₜ is the mass of the cellulose after impregnation.

Heat treatments were carried out at 140° C., 170° C. and 190° C. for 5/15/30/45/60 and 90 minutes.

After the heat treatment, the non-grafted polymer was extracted three times with refluxed dichloromethane.

Finally, hydrophobization of the cellulose was tested by the measurement of the contact angle of a drop of water as well as by infrared analysis with an ATR method.

Impregnation

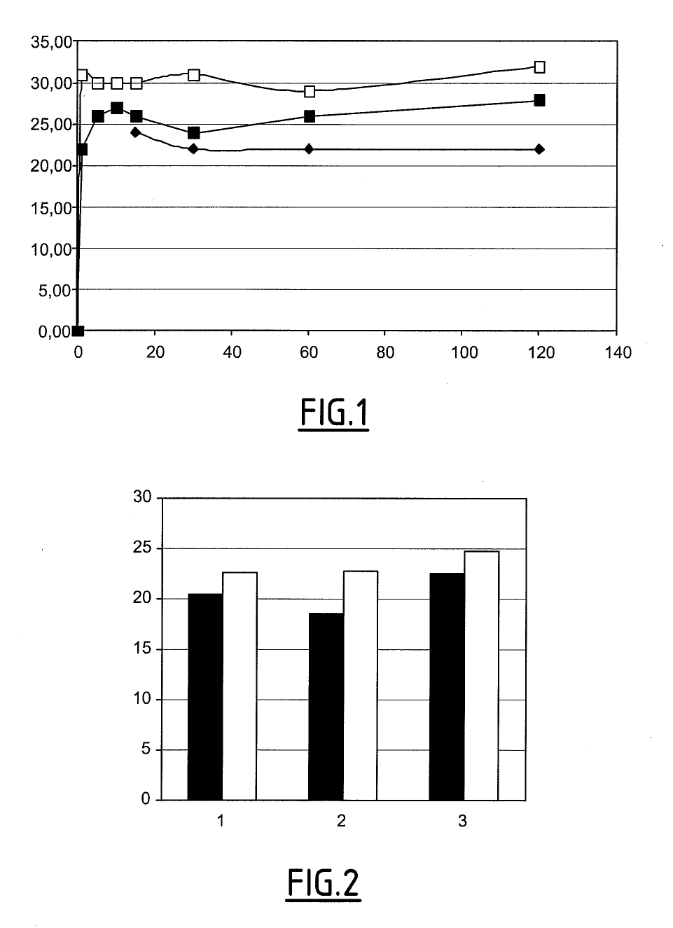

The cellulose (3×3 cm cellulose mat) was immersed in a solution of polymer (PHO, PHBHV and PHB) at 50 g/L in dichloromethane for a duration from 15 to 120 minutes. The cellulose was then dried at room temperature in order to allow evaporation of the dichloromethane. The mass of the cellulose as determined by gravimetry is plotted in FIG. 1. The results show that satisfactory results are obtained from an immersion duration of 15 minutes regardless of the nature of the polymer, in order to adsorb between 17 and 25 mg of polymer.

The number of immersion cycles was tested (from 1 immersion to 3 immersions within a duration of one hour). The results are shown in FIG. 2. It is seen that large amounts of polyesters are grafted regardless of the number of immersion cycles.

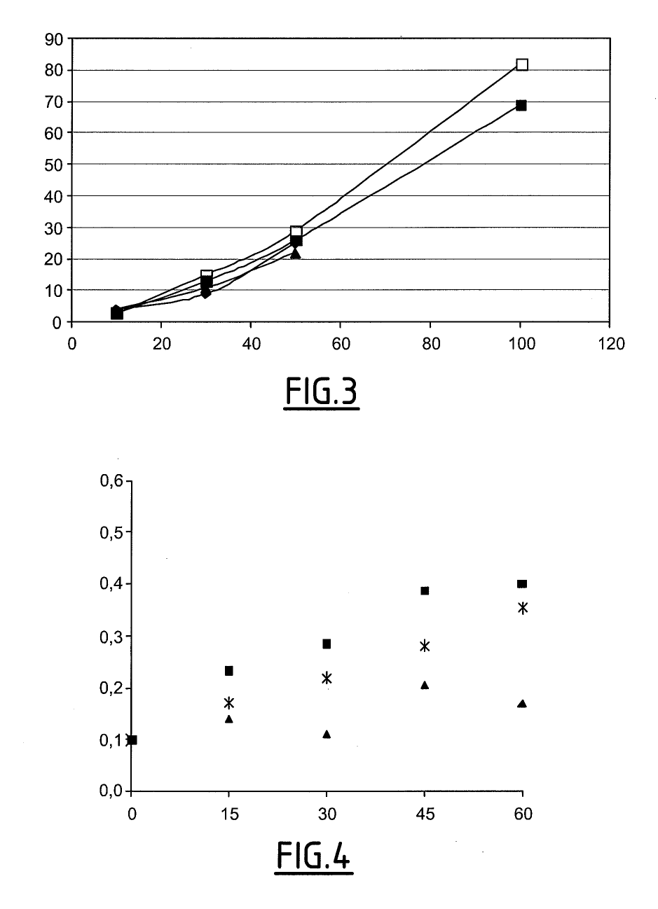

The influence of the PHA concentration was also studied (FIG. 3). It is therefore possible to modulate the amount of polyester adsorbed on the cellulose according to the concentration of the solution.

Grafting

The three following grafting methods were tested:

1) Reaction in a thermostated oven

After adsorption of the polyesters on the cellulose, the samples were placed in a thermostated oven at different temperatures (140° C., 170° C. and 190° C.). The reaction was conducted as a bulk reaction without any catalyst for durations ranging from 15 to 90 minutes. After reaction, the non-grafted polyester was extracted with three successive extractions in refluxed dichloromethane (3×40 mL) for 30 minutes.

2) Reaction under microwave irradiations

After adsorption of the polyesters on the cellulose, the samples were placed in a microwave appliance (microwave synthesis reactor monowave Anton Paar) at constant temperature, at 90° C. for 3 to 15 minutes.

3) Reaction under a heated press

Polyester films were prepared by evaporation of solvent or else by heating/pressing them between heated plates of a heated press. The applied duration and pressure vary with the nature of the polymer. In order to conduct the reaction, a cellulose mat was placed between two films of polyesters, and then the whole was heated between the plates of a heated press (without applying any additional pressure other than the weight of the two heated plates). The reaction was conducted at 170° C. for a duration comprised between 15 and 45 minutes.

The method under a heated press thus gives the possibility of omitting the solution impregnation step.

Demonstration of the Grafting by FTIR

The presence of polyester on the cellulose may be demonstrated by FTIR spectroscopy. The native cellulose has a wide band at 3380 cm⁻¹ due to the elongation of the OH bonds. The OH bond of water bound to cellulose absorbs at 1645 cm⁻¹.

At 1058 cm⁻¹, an intense peak is observed relatively to the elongation of the C—O bonds of the cellulose backbone. After grafting, a peak appears at 1745 cm⁻¹, corresponding to the elongational vibration of the carbonyl of the ester function. At 1235 cm⁻¹, the occurrence of a not very intense peak is observed relative to the elongational vibration of the C—O bond of the esters.

It is also possible to evaluate the polyester content by calculating the ratio between the absorbance due to the ester function and that of the chemical function bound to the cellulose. Subsequently, the ratio was therefore calculated between the absorption due to the elongational vibration of the ester function at 1745 cm⁻¹ and the absorbance of the OH bond of the water bound to the cellulose at 1645 cm⁻¹ with the purpose of comparing the grafted cellulose samples. This ratio is noted as A.

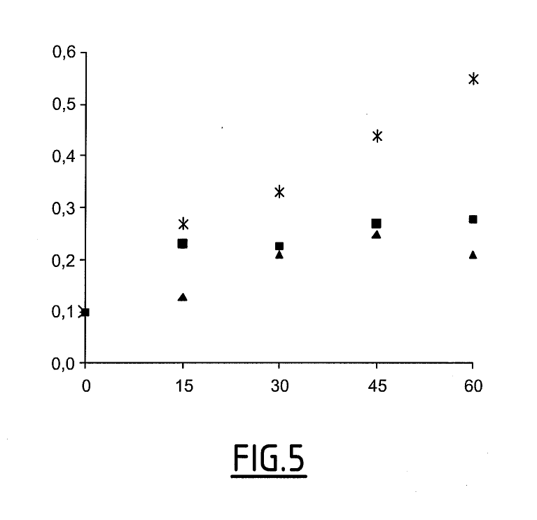

The ratio A defined by FTIR actually confirms the presence of the polyesters at the surface of the cellulose grafted with PHO and PLA (FIGS. 4 and 5). Indeed, the ratio A is greater than 0.15 and it increases linearly with the reaction time. This increase is enhanced with temperature. On the other hand for PHB, the band ratio is always less than those obtained for PHO and PLA.

### Example 1

### Method with Impregnation and Transesterification Reaction in a Thermostated Oven

The results of Table 2 below show that the grafting reactions by transesterification of PHO and PLA allow the surface to be made hydrophobic. These reactions are extremely rapid since they may be conducted within 15 minutes at 170° C.

TABLE 2
Contact angle on the cellulose after
transesterification with PHO and PLA

| | Temperature | Duration | Contact Angle |
|---|---|---|---|
| Polyester | (° C.) | (min) | (°) |
| PHO | 170 | 0 | 0 |
| | | 15 | 132 ± 4 |
| | | 30 | 135 ± 2 |
| | | 45 | 131 ± 4 |
| | | 60 | 131 ± 5 |
| | 190 | 0 | 0 |
| | | 15 | 135 ± 3 |
| | | 30 | 129 ± 2 |
| | | 45 | 134 ± 5 |
| | | 60 | 134 ± 2 |
| PLA | 170 | 0 | 0 |
| | | 15 | 129 ± 4 |
| | | 30 | 130 ± 2 |
| | | 45 | 134 ± 2 |
| | | 60 | 133 ± 3 |
| | 190 | 0 | 0 |
| | | 15 | 130 ± 4 |
| | | 30 | 130 ± 2 |
| | | 45 | 134 ± 2 |
| | | 60 | 133 ± 3 |

The results show that cellulose becomes hydrophobic after this treatment, which confirms the presence of oligomers of aliphatic polyesters at the surface of the paper sheets.

The additional results of Table 3 show that the grafting reactions by transesterification of PHBHV and PCL, at a temperature of 170° C., as well as of PLA, at 140° C., allow the surface to be made hydrophobic.

TABLE 3
Contact angles on the cellulose after transesterification
with PLA, PHBHV and PCL

| | Temperature | Duration | Contact Angle |
|---|---|---|---|
| Polyester | (° C.) | (min) | (°) |
| PHBHV^{a)} | 170 | 45 | 129 |
| (Mn = 88,000 g/mol) | | | |
| PLA | 140 | 45 | 126 |
| (Mn = 80,000 g/mol) | | | |
| PCL | 170 | 60 | 129 |
| (Mn = 4,000 g/mol) | | | |

^{a)}2 conducted cycles (impregnation/reaction in the oven).

### Example 2

### Method with Impregnation and Transesterification Reaction Under Microwave Irradiations

The results of Table 4 below show that the grafting reactions by transesterification of PHBHV, PLA and PCL give the possibility of making the surface hydrophobic. The use of microwaves allows a significant reduction in the duration of the reaction. Indeed, these grafting reactions are extremely rapid since they may be conducted in only 5 minutes at temperatures of 90° C. and 100° C.

TABLE 4
Contact angles on the cellulose after transesterification
with PHBHV, PLA and PCL

| | Temperature | Duration | Contact Angle |
|---|---|---|---|
| Polyester | (° C.) | (min) | (°) |
| PHBHV | 90 | 5 | 117 |
| (Mn = 88,000 g/mol) | | | |
| PLA | 90 | 5 | 126 |
| (Mn = 80,000 g/mol) | | | |
| PCL | 100 | 5 | 125 |
| (Mn = 4,000 g/mol) | | | |

The results show that the cellulose becomes hydrophobic after this treatment, which confirms the presence of oligomers of aliphatic polyesters at the surface of the paper sheets.

### Example 3

### Method with Transesterification Reaction Under a Heated Press Without Prior Impregnation in Solution

The results of Table 5 below show that the grafting reactions by transesterification of PLA and PCL, under a heated press, give the possibility of making the surface hydrophobic. These grafting reactions were conducted without any prior impregnation step in solution of the cellulose.

TABLE 5
Contact Angles on the cellulose after
transesterification with PHO and PLA

| | Temperature | Duration | Contact Angle |
|---|---|---|---|
| Polyester | (° C.) | (min) | (°) |
| PHO | 170 | 30 | 129 |
| (Mn = 80,000 g/mol) | | | |
| PLA | 170 | 30 | 133 |
| (Mn = 80000 g/mol) | | | |

The results show that the cellulose becomes hydrophobic after this treatment, which confirms presence of oligomers of aliphatic polyesters at the surface of the paper sheet.

B. Biocomposites Prepared from Other Biomaterials

The operating procedure for preparing (impregnating/grafting) biocomposites from silica, dextran, and polymers of cyclodextrins is identical with the one described earlier with cellulose.

The impregnation step is conducted by mixing silica powder (dextran or cyclodextrin polymer powder) and of PLA in the presence of a minimum of solvent.

The results of Table 6 below show that the grafting reactions by transesterification of PLA give the possibility of making the surface hydrophobic of biomaterials such as native silica, dextran and cyclodextrin polymers.

TABLE 6
Contact angles on different materials
after transesterification with PLA

| Polymer | Other Material | Temperature (° C.) | Duration (min) | γ (°) |
|---|---|---|---|---|
| PLA | silica | 170 | 45 | 82 |
| | dextran | 170 | 45 | 66 |
| | cyclodextrins | 170 | 45 | 92 |
| | polymer | | | |

The results show that the tested biomaterials become hydrophobic after this treatment, which confirms the presence of oligomers of aliphatic polyesters at the surface of the tested materials.

1. A method for preparing a hydrophobized biomaterial consisting of a hydrophilic material having hydroxyl functions, onto which are grafted chains of polymers having ester functions, said method comprising a step for contacting said hydrophilic material with said polymers and for a transesterification reaction between said ester functions and said hydroxyl functions.

2. The method according to claim 1, wherein the hydrophilic material is selected from vegetable fibers, silica, dextran or oligomers of cyclodextrin and derivatives thereof.

3. The method according to claim 1, wherein the transesterification step is carried out at a temperature comprised from 70° C. to 250° C.

4. The method according to any of claim 1, wherein the hydrophilic material is selected from vegetable fibers.

5. The method according to claim 4, wherein the vegetable fibers are selected from: cellulose and derivatives thereof, flax fibers, hemp fibers, abaca fibers, jute fibers, kenaf fibers, lyocell fibers, pine fibers, rayon fibers, sisal fibers, beetroot pulp, viscose fibers and nettle fibers.

6. The method according to claim 1, wherein the polymers having ester functions are selected from aliphatic polyesters.

7. The method according to claim 1, wherein the step for contacting the hydrophilic material with the polymers having ester functions is a step consisting of immersing said hydrophilic material in a solution comprising a suitable solvent in which the polymers having ester functions have been solubilized.

8. The method according to claim 7, characterized in that the concentration of polymers having ester functions in the solution is comprised from 10 g.L⁻¹ to 100 g.L⁻¹.

9. The method according to any of claim 7, wherein the solvent is selected from the group consisting of dichloromethane, chloroform and tetrahydrofurane.

10. A hydrophobized biomaterial, which may be obtained according to the method in accordance with claim 1, wherein the hydrophobized biomaterial consists of a hydrophilic material comprising hydroxyl functions on which are grafted chains of polymers comprising ester functions.

11. (canceled)

12. A composite material comprising a hydrophobized biomaterial according to claim 10 and a polymer.

13. A composite material of the “sandwich” type comprising a layer consisting of a hydrophobized biomaterial according to claim 10 and two layers of polymer, said polymer layers being respectively above and below the layer of hydrophobized biomaterial.

14. The method according to claim 3, wherein the temperature is comprised from 100° C. to 200° C.

15. The method according to claim 14, wherein the temperature is comprised from 140° C. to 190° C.

16. The method according to claim 7, wherein the duration of the immersion step is comprised between 10 minutes to 120 minutes.

17. The method according to claim 16, wherein the duration of the immersion step is equal to 15 minutes.

18. The method according to claim 8, wherein the concentration is comprised from 10 g.L⁻¹ to 50 g.L⁻¹.

19. The method according to claim 18, wherein the concentration is equal to 50 g.L⁻¹.

20. The hydrophobized biomaterial according to claim 10, where the hydrophilic material is selected from vegetable fibers.

21. The hydrophobized biomaterial according to claim 10, having a contact angle with water of at least 115°.
